(19) United States
(12) Patent Application Publication
(10) Pub. No.: US 2004/0243482 A1
(43) Pub. Date: Dec. 2, 2004

(54) Method and apparatus for multi-way jukebox system

(76) Inventor: Steven Laut, Norco, CA (US)

Correspondence Address: STEVEN LAUT, 3280 Kips Korner Road, Norco, CA, 92860, US

(21) Appl. No.: 10/446,406

(22) Filed: May 28, 2003

(51) Int. Cl. G06F 17/60

(52) U.S. Cl. 705/27; 705/26

(57) ABSTRACT

A jukebox system located at a first venue is presented. The jukebox system includes a display and a network interface both connected to a controller. The network interface selectively transmits/receives data and content on a network. A user interface is connected to the display and the controller. A first memory device and a second memory device are both connected to the controller. An output router is connected to the controller. An audio device is connected to the output router. A payment verification unit is connected to the controller. Content can be selected on the jukebox system at the first venue and played at least one other jukebox system located at a second venue and connected to the network.

### BACKGROUND

1. Field

This invention relates to jukebox systems, and more particularly to a method and apparatus for multi-way jukebox system including networked jukeboxes where content (i.e., audio, video/graphics, text) can be selectively transmitted for viewing, listening, reading, etc. to any jukebox in the network from any other jukebox in the network or from a management device.

2. Description of the Related Art

Jukebox systems typically are placed at venues in order for consumers to purchase music/audio or songs to be played at the particular venue. That is, prior art jukeboxes are one-way jukeboxes since content is played only from the individual jukebox requesting the content. These jukeboxes accept payment and in return, play music from either a compact disc (CD) or from a downloaded audio/video file, such as MP3 (Moving Pictures Expert Group (MPEG)-1 Layer 3 Audio), MP2 (MPEG-1 Layer 2), MPEG-N (e.g., MPEG-7), WMA (Windows Media Audio), ASF (Windows Media File-Advanced Streaming Format), ASX (Windows Media File), WM (Windows Media) WMV (Windows Media Video), ASX (Windows Audio File), MID (Musical Instrument Digital Interface), M3U (MP3 Playlist), PLS (Audio Playlist), RAM (Real Video Streamed), RM (Real Audio/Video Streamed), RMJ (Real Video), RA (Real Audio Streamed), AVI (Audio Video Interleaved), MPG (MPEG-1 Video), IVF (Intel Video Technology), VIV (Vivo Video), MOV, VQF, FLI, FLC, M1V, MPA, MPE, MPV2, ASF, etc.

Some systems can download music to multiple jukeboxes connected to a network. These systems only allow a consumer to play the downloaded content at the particular venue that the consumer is currently located, i.e. one-way jukeboxes.

FIG. 1 illustrates a prior art system where music/audio files are remotely stored on a server and can be downloaded to jukeboxes connected in the network. Music server(s) 110 stores the available music files that can be downloaded to jukeboxes 120. Encoder 150 is used to place music files in a particular format (e.g., MP3) or to encrypt the music file. Firewall 160 protects the system from being accessed by unprivileged machines. Management server(s) 130 can collect data and statistics from jukeboxes 120. The data can be: what songs are played from a venue, how much money each machine has taken in, and available memory on a jukebox. Statistics can be songs most played and top ten songs played. Statistics only flow from a jukebox 120 to the management server 130. However, overall statistics (e.g., top ten songs) can flow from the management server 130 to each jukebox 120. Separate jukebox statistics from each jukebox 120 does not get transmitted to other jukeboxes 120. In this system, music files are downloaded to each jukebox 120 through router 140. The music files can be downloaded simultaneously to one or more jukeboxes 120. But, the transmission is only from management server 130 to jukeboxes 120. Operators or owners of particular jukeboxes in the system can access management data and statistics from remote or local devices (e.g., personal computers) through Internet 170. Only a manager or operator can upload new music files to music server 110. A user located at a venue that has a particular jukebox can then select a downloaded song to play only at the particular venue where the user and the jukebox are located simultaneously. Usage fees (i.e., song play fees) are only collected through each jukebox in the system through a cash or credit card collection device.

### BRIEF DESCRIPTION OF THE DRAWINGS

The embodiments are illustrated by way of example and not by way of limitation in the figures of the accompanying drawings in which like references indicate similar elements. It should be noted that references in the specification to “an embodiment,” “one embodiment,” “some embodiments,” or “other embodiments” means that a particular feature, structure, or characteristic described in connection with the embodiments is included in at least some embodiments, but not necessarily all embodiments, of the invention. The various appearances “an embodiment,” “one embodiment,” or “some embodiments,” are not necessarily all referring to the same embodiments. If the specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

FIG. 1 illustrates a prior art jukebox system.

FIG. 2 illustrates an embodiment of a multi-way jukebox system.

FIG. 2A illustrates an embodiment including at least one integrated central processor unit (CPU).

FIG. 3 illustrates one embodiment having a simulated remote control.

FIG. 4 illustrates one embodiment where remote signals are sent to the jukebox system at the venue selected to transmit images from.

FIG. 4A illustrates one embodiment having a menu for entering personal content selections.

FIG. 4B illustrates an example of a menu in which a user's personal selected content is displayed.

FIG. 4C illustrates one embodiment where various menus of organized content are displayed for a user to choose from.

FIG. 5 illustrates one embodiment having menus that are dynamically modified based on statistical information from any venue that is coupled to a network.

FIG. 6 illustrates an example of content priorities.

FIG. 7 illustrates one embodiment having a menu that a user can use to select jukeboxes that allow content to be played based on availability for content criteria.

FIG. 8 illustrates one embodiment where after the cost is displayed on a display, a user can be assisted to lower the content cost.

FIG. 9 illustrates that an example of image format adjusted to simultaneously fit multiple venue images on a display.

FIG. 10 illustrates one embodiment where a jukebox system further includes a content downloading port.

FIG. 11 illustrates one embodiment where a jukebox system further includes compact a disc (CD) writer, compact disc feeder (not shown) and CD delivery device.

FIG. 12 illustrates one embodiment where a karaoke selection can be made on a jukebox system.

FIG. 13 illustrates one embodiment where content can be transferred from a memory device to a deletion memory device.

FIG. 14 illustrates a multi-way jukebox system network (JSN).

FIG. 15 illustrates one embodiment where each venue having a jukebox system may use remote desktop units.

FIG. 16 illustrates a process for selecting content to be played on one or more multi-way jukebox systems in a network.

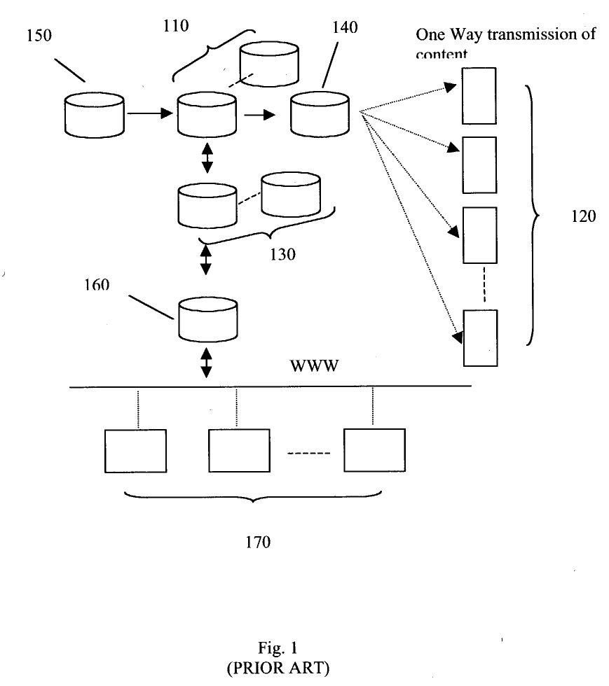

### DETAILED DESCRIPTION

The invention generally relates to multi-way jukebox systems that can play/show/etc. content (i.e., audio/video/text/graphics/etc.) on jukebox systems that are networked, where a user can select any or all jukebox systems to play content, to/from any jukebox system in the network, or from a remote device coupled with the network. Referring to the figures, exemplary embodiments of the invention will now be described. The exemplary embodiments are provided to illustrate the invention and should not be construed as limiting the scope of the invention.

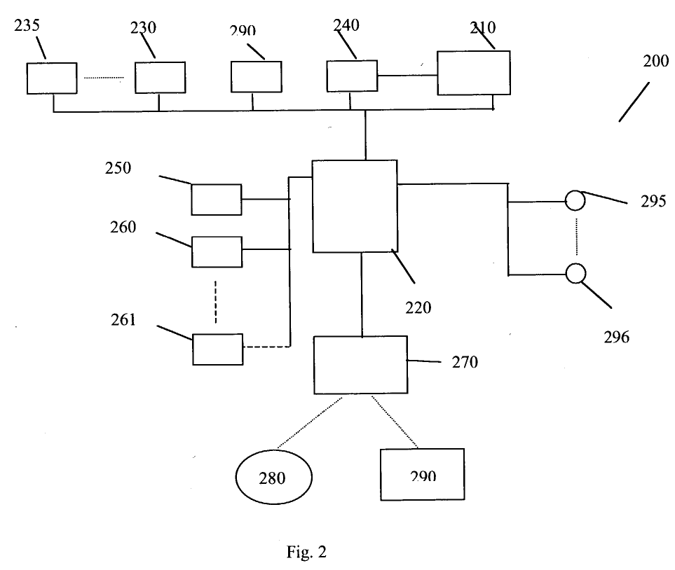

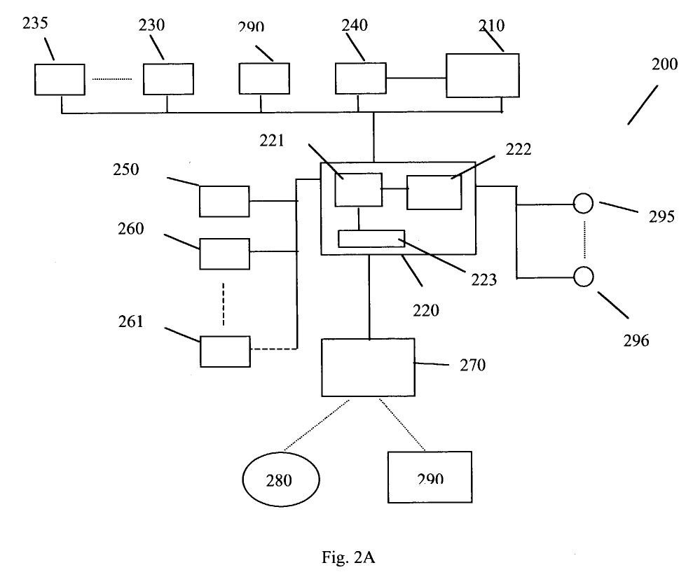

FIG. 2 illustrates a multi-way jukebox system. Jukebox system 200 is placed at a particular venue, such as a bar, a pizza parlor, a restaurant, etc. In one embodiment, jukebox system 200 includes first display 210, controller 220, first network interface 230, network interface N 235, user interface 240, first memory device 250, second memory device 260, memory device N 261, output router 270, audio device 280, and payment verification unit 290. In one embodiment, first display 210 is an embedded display in jukebox system 200 (i.e., part of the basic jukebox system 200 enclosed floor or wall mounted device). In another embodiment, first display 210 is a modular component that is remotely coupled to user interface 240 (e.g., wireless coupled (by wireless technology known to those skilled in the art), directly wired, etc.). First display can be any known type of display device, such as liquid crystal display (LCD), cathode ray tube (CRT), flat screen technology, projection display, etc.

FIG. 2A illustrates an embodiment with controller 220 including at least one integrated central processor unit (CPU) 221. In this embodiment, controller 220 includes processes for scheduling, prioritizing content, routing signals and messages, transmitting content, receiving content, playing content, accepting fees, transmitting/receiving data, coupling to a network, verifying payment (whether electronically made (e.g., credit card) or manually (placing money in a money receiver), storing content to memory, filtering content signals for karaoke play, displaying content information on a display, etc. In another embodiment, controller 220 includes components of a personal computer (PC), such as a notebook or desktop type computer. It should be noted that controller 220 also contains memory controller 222 for handling memory store/delete/transfer, etc. operations in for the memory devices included in jukebox system 200.

Jukebox system 200 preferably plays content that is in the form of a memory file, e.g., the content is in the form of: audio/video file, such as MP3 (Moving Pictures Expert Group (MPEG)-1 Layer 3 Audio), MP2 (MPEG-1 Layer 2), MPEG-N (e.g., MPEG-7), WMA (Windows Media Audio), ASF (Windows Media File-Advanced Streaming Format), ASX (Windows Media File), WM (Windows Media) WMV (Windows Media Video), ASX (Windows Audio File), MID (Musical Instrument Digital Interface), M3U (MP3 Playlist), PLS (Audio Playlist), RAM (Real Video Streamed), RM (Real Audio/Video Streamed), RMJ (Real Video), RA (Real Audio Streamed), AVI (Audio Video Interleaved), MPG (MPEG-1 Video), IVF (Intel Video Technology), VIV (Vivo Video), MOV, VQF, FLI, FLC, M1V, MPA, MPE, MPV2, ASF, etc. Content, however, can be in the form of a compact disc or streams as well. In one embodiment, content can be is the form of a compact disc, DVD, memory file, or any combination,

User interface 240 can be any known type of input device(s), such as a keyboard, a mouse, a resistive digitizer (i.e., touchscreen), voice control, etc. (these devices can be directly wired or wireless). User interface 240 is used by a user of jukebox system 200 to enter selection of music/video/text/graphic content choices, enter a user identification and password to access a personal selection song/video list stored remotely on a server connected to a network, such as the Internet, etc., select a venue having a similar jukebox system 200 connected to the network for which to play selected content, etc. In one embodiment, user interface 240 is embedded in display 210 as a resistive digitizer (i.e., touchscreen) that allows selection of music/video categories, personal information (ID, password, etc.), venue selection, device options, etc. In another embodiment, user interface 240 is remotely coupled either by a wireless connection (such as WiFi, bluetooth, wireless network, etc.) or a directly wired connection. In another embodiment, user interface also includes a pointing device (e.g., a trackball mouse), a keyboard, buttons, etc.

Payment verification device 290 verifies that a user has entered payment in order to play a user selection on jukebox system 200, or any other jukebox system that is coupled to a network in which jukebox system 200 is also coupled or removably coupled. In one embodiment, payment verification device 290 comprises a money (fee) acceptor/receiver (e.g., monetary bills and coins). Any typical known monetary acceptance devices can be employed in payment verification device 290. In another embodiment, payment verification device handshakes with a credit card/debit card entity to accept payment from a credit card holder/debit card holder's account. In this embodiment, payment verification device 290 communicates (over the network or via a telephone line, cellular connection, etc.) with an outside credit/debit company and waits for verification (i.e. approval) before giving a user of jukebox system 200 credit to play his/her selection. Any known types of payment verification systems can be used in payment verification device 290. In this embodiment, a credit card reader is coupled to jukebox system 200. A user can slide or insert a credit card or debit card into the reader, which than transmits user information to/from a credit card or bank system to enable payment to be made for content selection. It should be noted that personal user accounts can also be used that have credit limits or are replenished by use of an associated debit card. In this fashion, a user need not have monies or credit/debit cards with them in order to use the features of the jukebox system.

Network interface 230 can be any known network card that allows jukebox system 200 to couple with a network, such as the Internet. Therefore, network interface 230 can be a network card that couples with a DSL modem, standard modem, cable modem, etc. In another embodiment, more network interfaces (such as network interface N 235) are coupled to controller 220 to allow additional connections to a network (such as the Internet) to allow upload/download information to be transmitted/received to/from jukebox system 200. Network interface N 235 can be any network interface card to transmit/receive data by satellite, telephone, cable modem, DSL modem, etc. Therefore, jukebox system 200 can transmit/receive data from multiple sources to allow increase in speed of data transmission/reception. In one embodiment, jukebox system 200 couples with a network via a wireless connection (such as wireless Ethernet, etc.). In this embodiment, placement of jukebox system 200 can have more choices of situation in a venue because of the feature of a wireless network connection.

First memory 250 can be a storage device such as a hard drive or collection of hard drives that store music/video data on jukebox system 200. First memory 250 is large enough to store most, if not all, available music/video that is available to be played on any jukebox system coupled to a network in which jukebox system 200 is coupled with or removable coupled with. Therefore, first memory 250 can act as a database or depository of music/video in order to upload to any jukebox system coupled with or removably coupled with jukebox system 200 and the employed network, such as the Internet. One skilled in the art should know that any available type of hard drive(s) or removable hard drive(s) or memory device(s) can be used. Therefore, memory 250 storage capacity is in the order of a plurality of gigabytes, terabytes, etc. (e.g., 100,000 content that is 1.5 MB each=150 GB, 500,000 content at 1.5 MB=750 GB, etc.). In another embodiment, additional memory devices similar to, or compatible with, first memory 250 can be added in order to increase stored content for selection by a user (as necessary; i.e., addition of removable or non-removable hard drives or memory cards).

In one embodiment memory 260 is a faster memory device than memory device 250, i.e., memory 260 is a temporary memory device. Memory device 260 can be any type of memory such as RAM, DRAM, SRAM, SDRAM, CAM, etc. Memory 260 is used to store a current content selection or multiple content selections that are queued to be played on jukebox system 200. Memory 260 works in conjunction with cache memory 223 coupled within controller 220 to allow smooth playing without interruptions to music/video/graphics/text/etc. Memory 260 is sized accordingly to hold a plurality of content selections, such as 128 MB, 256 MB, 512 MB, 1024 MB, 2048 MB, 4096 MB, etc. In one embodiment, music/video is first stored on memory device 250 before a copy is transferred to memory 260 as selected by a user. In another embodiment, music/video content is first stored on memory device 250 before a copy is transferred to memory 260, before being transferred to a cache memory within controller 220. The cache memory has a size capable of holding at least one music video or content file. In one embodiment, the cache memory can be from 512 KB to 10 MB. Controller 220 controls a memory controller, which controls both memory 250 and 260 (and cache memory 223: see FIG. 2A) and directs uploaded/downloaded etc. data/music/video/etc. to both memory devices. In another embodiment, multiple memory devices of each type of memory device 250 and 260 are coupled to controller 220 to allow smooth playing/downloading/uploading of music/video/data/etc. to/from jukebox system 200. In this embodiment, memory device N 261 represents the additional memory devices, where N can be any suitable number to accommodate storage of all content in the network (i.e., N ranges between 5-20).

In one embodiment, optional second display 290 (illustrated in FIG. 2) is coupled to output router 270. Optional second display can be remotely or directly coupled to jukebox system 200. Therefore, display 290 can be located with or away from jukebox system 200. Display 290 can be sized according to a venue operator/owner's preference. Thus, display 290 can be any available sized display monitor and any available technology type of display as desired. Therefore, display 290 can be a flat screen, projector display, CRT monitor, LCD, plasma, etc. In one embodiment, display 290 is 40-90 inches measured diagonally. It should be noted that a plurality of displays 290 can be coupled to jukebox system 200. In one embodiment, displays 290 can be distributed throughout a venue.

In another embodiment, optional camera 295 is coupled to controller 220. Optional Camera N 296 (illustrated in FIG. 2) illustrates that any number of cameras can be coupled to controller 220 for various stationary or panning views of a venue where jukebox system 200 is situated. Camera 295 (and camera N 296) can be any type of camera available that can transmit images (either still or motion) through a network environment, such as Internet cameras, digital cameras, etc. Camera 295 can be situated either directly coupled to or remotely coupled to controller 220. Camera 295 and 296 can transmit live images to display 290 or to any other jukebox system coupled with or removably coupled with jukebox system 200 when coupled to a network, such as the Internet. In one embodiment, a user pays a fee for a certain time of video transmitted from the selected venue. In this embodiment, the video displayed at the user's particular venue can be delayed. That is, a video can be recorded and the video file (e.g., MPEG file) is transmitted through the network to the jukebox system located where the user is (or to where the user selected the imaging to be displayed). Therefore, the video file may not be a real-time video, but a delayed or imaging that recently took place. In one embodiment, the time the imaging was captured is displayed on the video output so a user can tell when the imaging was recorded. In another embodiment, a live camera video feed is sent in real-time or only slightly delayed. In one embodiment venue information (name, address, telephone number, current specials, etc.) is displayed along with the video (or still photo) on a display or displays, such as display 290.

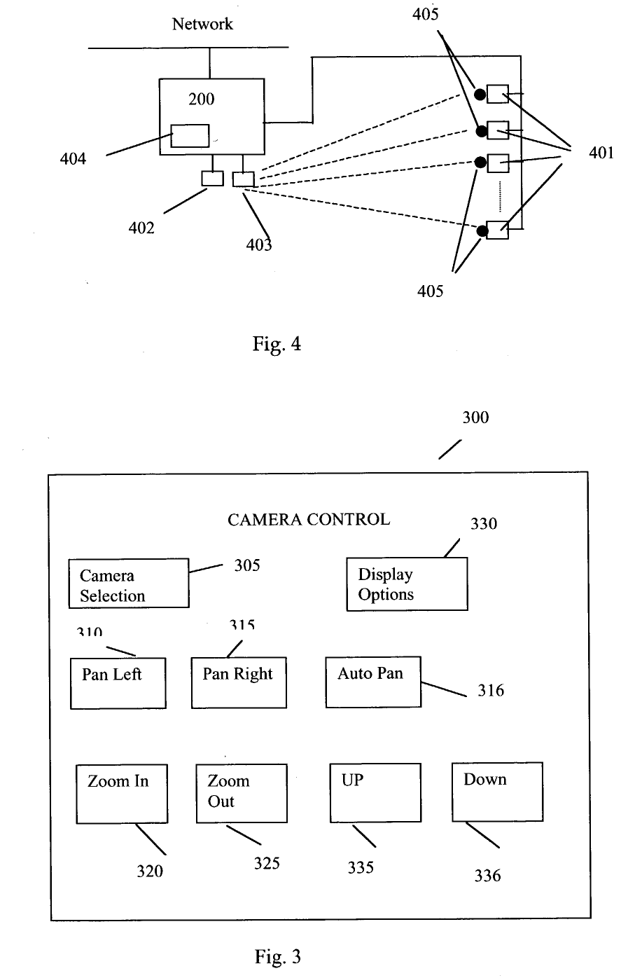

In another embodiment, the user can enter commands through user interface 240 to direct cameras at other venues to move in the specified directions and/or to zoom in/out. In this embodiment, a signal is received at the venue where the camera to be commanded is located. FIG. 3 illustrates one embodiment having a simulated camera remote control that is displayed as a menu on display 210. The simulated remote control allows the features of pan left 310, pan right 315, auto pan 316, zoom-in 320, zoom out 325, upward movement of the camera (up 335), downward movement of the selected camera (down 336), camera selection 305 and display options 330. Display options 330 allows a user to choose how to display the received video signals on a display. For example, if multiple cameras are used (either at one or more venues), a user can select the option of side by side, over and under, etc. image display formats. Auto pan 316 slowly moves the selected camera from left to right (or vice versa) and back at a slow rate without the user having to manually adjust the camera. In one embodiment, if the user wants to stop the auto pan feature, the user just selects pan left 310 or pan right 315. Other options are available as well, e.g. a cancel button. Camera selection 305, when selected, shows all available cameras for the selected venue(s). Therefore, a user can control a camera that is placed on a motion base that can accept remote signals.

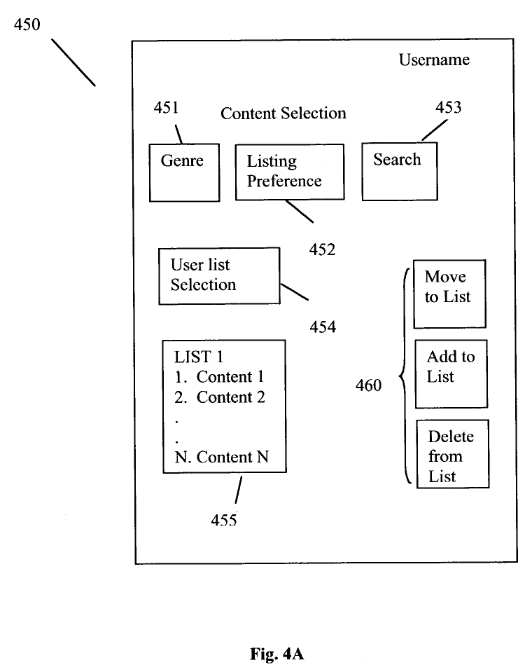

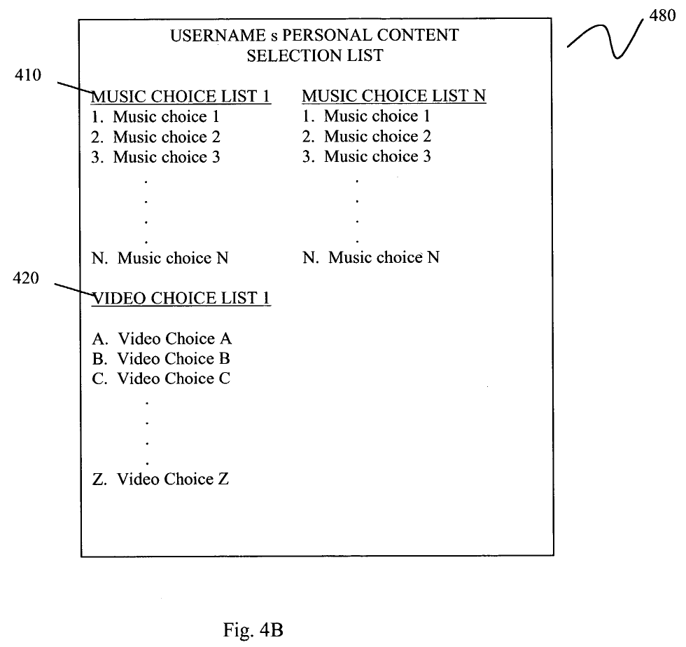

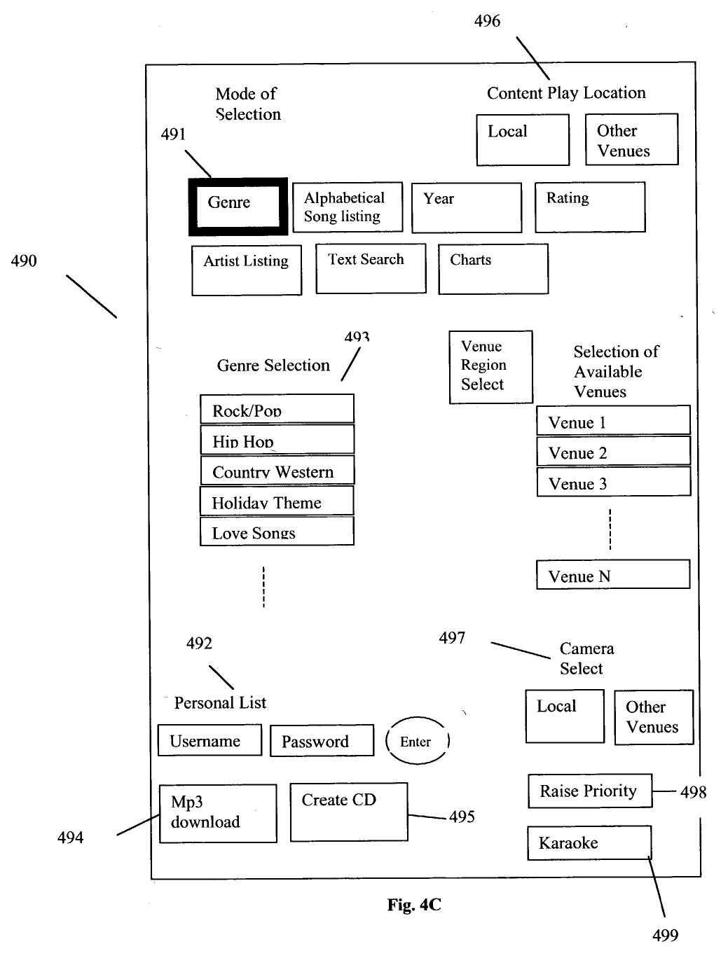

FIG. 4 illustrates one embodiment where the remote signals are sent to the jukebox system at the venue selected to transmit images from. As illustrated in FIG. 4, jukebox 200 includes receiver 402 and transmitter 403. Cameras 401 are coupled to the network if located at a different venue than the venue located where jukebox 200 is located. If cameras 401 are located at the same venue as jukebox 200, then cameras 401 are directly coupled to jukebox 200. The commands are translated to either radio frequency (RF) or infrared (IR) signals by encoder 404 coupled to jukebox 200. A transmitter located at the venue (e.g., coupled with jukebox system 200) transmits the signals. The signals then cause the actions on the commanded camera. Typical remote control devices (i.e., receivers/transmitters) can be used to command a camera and/or camera motion base 405.

It should be noted that if multiple users wish to view the same venue through a camera coupled to a jukebox system, then multiple copies of the images (i.e., copies of file(s) or streams/packets) are sent to each user's remote connection or jukebox system. If there are multiple user's accessing the same venue's camera's, and the camera has the capability of being controlled through a user interface (i.e., zoom, pan, etc.), then the first user that selected the venue is given control of the camera control. As the user that had control of the camera's time runs out (i.e., the time paid for has been used up), the control switches over to the next user that selected the camera. In one embodiment, a predetermined limit on simultaneous camera availability exists in order to limit the number of image copies being sent over the network to remote connections and/or jukebox systems. The predetermined limit can be modified based on usage, available bandwidth, available memory, etc. Therefore, the predetermined limit can range from 1 to any number of jukebox systems and/or remote connections. In one embodiment, the limit can change dynamically based on usage, available bandwidth, available memory, etc.

One feature of jukebox system 200 is that content (e.g., music/video/graphics/text/etc.) can be selected on jukebox system 200 at its situated venue and played on either jukebox system 200 (i.e., played at its own venue) or any, all or subset of all available jukebox systems located at other venues that are coupled to a network that jukebox system 200 is coupled with. This feature allows users located at different venues to send/receive content to each other. This feature is different from typical jukebox systems where a user can only play selected content at the particular venue where the jukebox and user are both situated, simultaneously.

FIG. 4A illustrates one embodiment having menu 450 where a user of jukebox system 200 can enter personal selections (i.e., create a preferential content list) remotely through a remote system (e.g., a website running on a server) or from the jukebox system, store the personal selections on a remote server, where the personal selection can be retrieved by the user on any jukebox system 200 (or remote device/terminal) that is currently coupled with a network (such as the Internet). In this embodiment, a user has an associated identification and password. The identification and password allow security for the user from others modifying or viewing the users personal content selections. In this embodiment, a user can predetermine content that is desired to be played at any jukebox system coupled to a network. That is, a user doesn't have to search a jukebox system's menus in order to select content to play. The user simply retrieves his/her preferential content list, and selects content to play from their own list(s) (see FIG. 4B). The user can select content by genre, (e.g., genre selection 451, which displays content related to genre after the user selects desired genre), listing preference 452 (i.e., ratings, alphabetical song or artist, etc.), or text search 453. The user can move selected content to a different personal list by selecting move to list; can add to a list, or delete from a list (via user selection 460). the user selects the list(s) by user list selection 454.

In one embodiment, a display menu(s) is created including the user's preferential content list. The user can then select any or all of his content listed on the created menu on jukebox system 200 for selection and play (at the jukebox system or on any other jukebox system in a network).

The user enters his/her identification and password through user interface 240 and can retrieve personal selections of content the user can select from (i.e., any subset or the complete selection). This feature saves time for a user at a jukebox system because the user can retrieve all selections of content that the user selected before arriving at the jukebox system. The user then simply views the personal content selection on menu 450 on display 210. Typical users of prior art jukebox systems can spend a lot of time deciding on music or videos from which to select. Therefore, time can be saved by a user by viewing his/her personally selected content at any jukebox system coupled to a network.

In one embodiment, a user can modify his/her personal selection of content at jukebox system 200 through user interface 240. Since the personal content information is stored at a remote server, the personal content is retrievable at any jukebox coupled to a network that is also coupled to the server where the personal selection content is stored. One should note that known methods for retrieving remote information can be used to retrieve personal content selection information on any jukebox system 200. In this embodiment, the users personally selected content is displayed on display 210 on a selection menu(s).

FIG. 4B illustrates an example of a menu in which a user's personal selected content is displayed. In another embodiment, a sound system (not shown) coupled locally to display 210 instructs a user verbally on how to select content from the user's personally selected content list. Menu 480 includes a user's music and video selection lists. In menu 480, music list 410 illustrates a user's selection list(s) from which a user can select his/her pre-selected music content to be played at any jukebox system that is coupled to a network, such as the Internet and jukebox system 200. In menu 480, video list 420 illustrates a user's selection list(s) from which a user can select his/her pre-selected video content to be played at any jukebox system that is coupled to a network, such as the Internet and jukebox system 200. One should note that other graphical layouts can be used to display a user's personal selection list.

FIG. 4C illustrates one embodiment where various menus of organized content are displayed for a user to choose from on display 210. The menus can be organized according to genre, content ratings (e.g., PG, R, X, etc.), year of distribution (i.e., 1950's, 1970's, 1990's, etc. year specific, e.g., 1951, 1955, 1991, etc.), alphabetical (either by song/video title or artist last name), charts (i.e., top 100 of a specific year, top songs/videos at the particular venue or any other venue, etc.), currently playing or scheduled content at other venues, etc. In one embodiment, to make it easier for a user to find desired content, the user can enter at least one of a year, artist name, song/video title, etc. through text search selection via mode of selection 491. Controller 220 than processes the entered text from a user to search a database (located on a remote server) that is dynamically updated through a server program (i.e., with search terms, new content and the content's associated search terms, etc.; not illustrated) coupled to a network in which jukebox 200 is coupled. Known searching techniques and database sorting techniques to those skilled in the art can be used in this embodiment.

Also illustrated on FIG. 4C is venue location selection 496, where a user chooses either local or remote play. Camera select 497 allows a user to choose cameras to transmit content to selected venues. Other selections illustrated on menu 490 are personal content list selection 492, MP3 download selection 494, CD creation selection 495, raise priority selection 498, and karaoke selection 499. For a user to retrieve their own personal list, a user enters a username and password. Jukebox system 200 then retrieves the user's personal content list(s) and displays the personal list in a menu (see FIG. 4B).

In one embodiment, a user can enter text through user interface 240 to be displayed at another venue that has another jukebox system 200 coupled to a network in which jukebox 200 is coupled. In this embodiment, a content rating program can be employed to restrict displaying of terms that exceed a particular venue's selected rating limit. For example, if a user wants to display profanity at another venue, the rating screening program can screen out profane words from being displayed. In one embodiment, a list is used to sort through to compare the entered words with. In another embodiment, known screening or filtering programs can be used to limit profane content (i.e., similar with known parental guidance/privilege programs). In another embodiment, an owner or proprietor can add certain words to a list to be searched (for exclusion). In this embodiment, a particular venue can thus screen certain terms (e.g., political, names, etc.).

It should be noted that each jukebox system (e.g., jukebox system 200) can be limited to the type of content that can be played either at the venue or from another venue to the jukebox system. Therefore, an owner or proprietor can control content genre, rating, camera images, etc. (i.e., control preference of features). For example, an owner at a country western establishment can refuse playing of hip-hop, rock, etc. from its own venue or from other coupled venues. Another example is a pizza parlor owner that has children accompanying adults. In this venue, an owner can limit ratings of content that are selectable, or would otherwise be allowed to be played at the venue from another jukebox location or remote connection. It should be noted that an owner or proprietor can enter the content limits either directly on the jukebox system through user interface 240, or from a website that is coupled to the network in which the jukebox system is coupled to. In this embodiment, an owner or manager enters an identification and password to a management program. The management program then allows an owner to manage (i.e., control) content allowable at the manager's venue. Also, an owner or proprietor can limit ratings, genre, year of content, specific artists, etc., to have special content nights, such as ‘70’s night, Beach Music night, Christmas music only, etc.

In one embodiment, a manager can vary the allowable content for different time periods. In this embodiment, if children are allowed in the venue only to a certain time, the owner can change the ratings dynamically to adjust to their own particular schedule (i.e., the owner can program when to switch over to different ratings levels through a scheduling program that automatically switches rating at a specified time period). Since a network, such as the Internet, is accessible remotely, a manager can remotely couple to the management program running on a management server and amend the allowable content that can be selected on his or her's particular jukebox system located at his or hers's venue. It should be noted that a manger can also select the option of coupling or decoupling from the network (i.e., only allowing content to be selected or entered from the jukebox system, but not allowing downloading of content or playing of content selected by other venues. Therefore, when it is desirable for a manager not to receive content transmitted from other venues, the manager can disable the feature of allowing others to view images or play content to that venue's jukebox system.

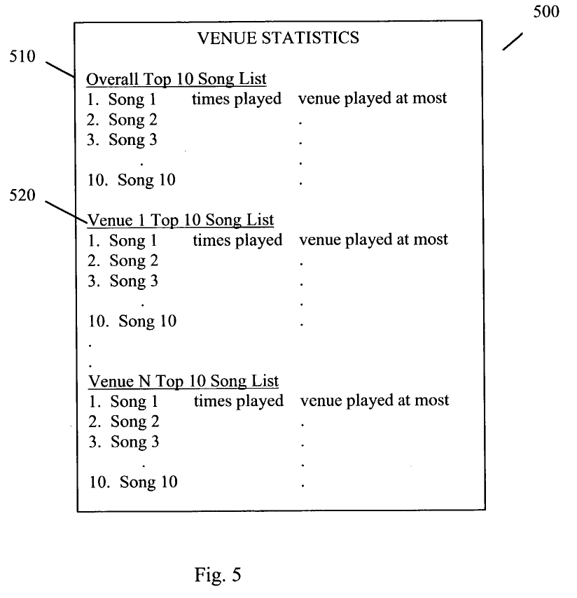

FIG. 5 illustrates one embodiment having menus that are dynamically modified based on statistical information from any venue that is coupled to a network in which jukebox system 200 is coupled to. Menu 500 illustrates statistical information from any/all/subset of jukebox systems coupled to a network for which jukebox system 200 is coupled or removably coupled to. Menu 500 includes statistical lists, such as list 510 that illustrates the overall top ten songs (or any other number of top songs) requested on the network, and list 520 shows the top ten selected songs from any venue's jukebox system. It should be noted that any other statistic information and list can also be made. For example, the ten least selected songs, the top ten songs in a specific genre or rating, etc. The content play and other data (e.g., money collected, number of songs played, videos played, etc.) information from each jukebox system coupled to the network is stored on a remote server. The server has a program that can determine statistically the top ten songs either overall or genre or rating specific, money collected, etc. This information is downloadable to any jukebox system coupled to the network, not just a management server. From the information, menus are dynamically amended to show the correct statistical information. A user can then select from the statistical menu created content to be played.

It should be noted that while FIG. 5 illustrates top ten songs, that any other statistical menu can be created, e.g., top 100, venue that collected the most money, least money, etc. In another embodiment, a menu can be created that shows top songs played in a specific region of coupled jukebox systems (e.g., by state, city, country, type of establishment, etc.) Therefore, a user can know what the top songs are at different venues, cities, states, countries, type of establishments, and can select songs from the menu lists. It should be noted that the menus can be created based on known graphical programming technology, such as windows, open windows, Java™, Visual Basic™, etc.

In one embodiment, jukebox system 200 displays statistical information for content on menus displayed on display 210. In this embodiment, statistics, such as number of times played at current venue, number of times played at selected venue, overall times played throughout the network, number of times played in different zones (i.e., states, countries, cities, etc.), etc. In this way, a user can tell how many times content has previously been selected. The statistical information can be used by a user or someone that is curious as to the statistics of the content.

In one embodiment, the statistical information is selectable (i.e., a user can turn on or off the displaying of the statistical information through a switch selectable from the user interface (i.e., through software). The statistical information is collected at a remote server, transferred from controller 220 in jukebox system 200. Every time content is selected to be played on a jukebox system(s), the controller 220 transmits the information on the network to a remote server. The remote server has a program that collects the information in a database. The database has a plurality of fields to store data for every jukebox system coupled to the network (by code number associated with each jukebox 200 in the network, e.g., IP address, etc.). Each jukebox system can also have codes for cities, state, type of establishment, etc. A database-sorting program is used to sort the information requested to be displayed on a jukebox system. The remote server then transmits the information back to the venue where the information was requested. This information can be valuable to an artist or marketing company to see how certain content is preferred in certain specified locations. A marketing or promotional company can then use this information to launch marketing or promotional plans, schedule concerts, etc.

In one embodiment, jukebox system 200 displays emergency information on display 290 (or 210). In this embodiment, an option of a sound recording can also be played on jukebox system 200. In one embodiment, the emergency content can comprise data such as: Zoned or national Amber alerts, Federal Bureau of Investigation (FBI) alerts, local weather advisories, local police alerts, leadership (e.g., presidential) alerts, emergency broadcast system alerts, local/regional/national disaster alerts, etc. In one embodiment, a specific video/graphical display is made that corresponds to the particular alert to distinguish it from other alerts. For example, an Amber alert may have a flashing amber display (video, graphics, text, etc.) on display 290 and a certain tone or signal heard from audio device 280. Once patrons at venues with jukebox systems coupled to a network see/hear the particular alerts, they will become accustomed to or recognize the particular alert based on its specific notification (i.e., sound/video). Typically, these type of alerts are only viewable/hearable on radio and television or freeway advisory displays. Therefore, jukebox system 200 can now spread information to persons that may not be accessible to a radio or television set, or who would normally not be paying attention to a radio or television set where a typical jukebox system would be situated.

In the embodiments where emergency alerts are made, the alerts can be made simultaneously to all jukebox systems coupled with the network in certain regions (i.e., states, cities, countries, etc.), or staggered at different venues based on the current content being played finishing. In this embodiment, controller 220 determines if an emergency content is downloaded to jukebox system 200 based on information in the data packet(s) or stream(s) received through the network. For example, a header of a data packet or file can contain a priority code that is recognizable by controller 220. Once controller 220 determines that a priority code for an emergency alert has been received, controller 220 will play the content by priority basis. In one embodiment, a jukebox system that is currently not coupled to the network is automatically coupled to the network for the playing of the emergency alert. In this embodiment, after the emergency content is played, the jukebox system returns to the uncoupled condition. In this embodiment, a packet, steam or file of emergency data contains a code that can switch on a jukebox network card. Known techniques can be used to switch on/off a jukebox system through a data packet/stream/file.

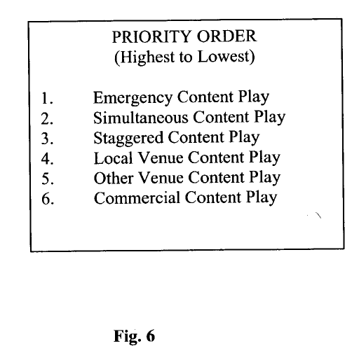

In one embodiment, songs and videos played from the venue where the jukebox system is located would have a priority higher than content sent from other venues (remote devices), but lower than emergency alerts. In another embodiment, content from all venues (including the local venue) have equal priority and, therefore, play in order of selection (e.g., based on time selection is made, i.e., FIFO). In one embodiment, controller 220 determines priority at preselected time intervals (e.g., every minute, every two minutes, etc.). In another embodiment, controller 220 polls for priority upon a new selection being made either at the particular venue where a jukebox system is located or from other venues. Therefore, position in a playlist can be reordered based on priority (i.e., modify the order of the FIFO list). FIG. 6 illustrates an example of priorities listed from highest priority (1) to lowest (6).

In one embodiment, a user can select content to be played at any venue from a remote location. In this embodiment, the user can remotely couple to a network in which a jukebox system is coupled. Therefore, a user can remotely connect to a website accessible from a network, such as the Internet, and select content from menus on the website that are similar or the same as menus displayed on display 210 of a jukebox system, such as jukebox system 200. In this embodiment, a user can pay for the selection of content to be played by a credit card or debit card. A program or process that is running on the server will determine which venues the selected content can be played on based on availability (e.g., if the owner or manager allows the type of music, the rating is allowable, preferred genre, etc.). Therefore, a user can play selected content without even being at a venue where a jukebox system is coupled to the network. In one embodiment, a user is notified when his/her content has played by a message either to the user through his/her personal account, or through an email message.

In one embodiment, a user can select content to be played at any number of venues that have jukebox systems coupled to a network. In this embodiment, a user can select a plurality of jukebox systems to play the same content on, either simultaneously, staggered or on an availability basis (i.e., the selection is placed in a FIFO queue and played based on priority). In this embodiment, a user selects the content that is desired to be played first. The system checks network connections and privileges (i.e., allowed: genre, ratings, camera(s), etc.). A menu then displays the total number of venues available. In one embodiment, a user can select a specific region, or specific venues. In this embodiment, a user can select regions first, such as a state a city, a country, etc. When the available venues are then displayed, the user can select any or all of the available venues at which to play selected content. One should note that price is effected based on the user's selection (i.e., to play simultaneously, staggered, etc.), number of venues played, etc.

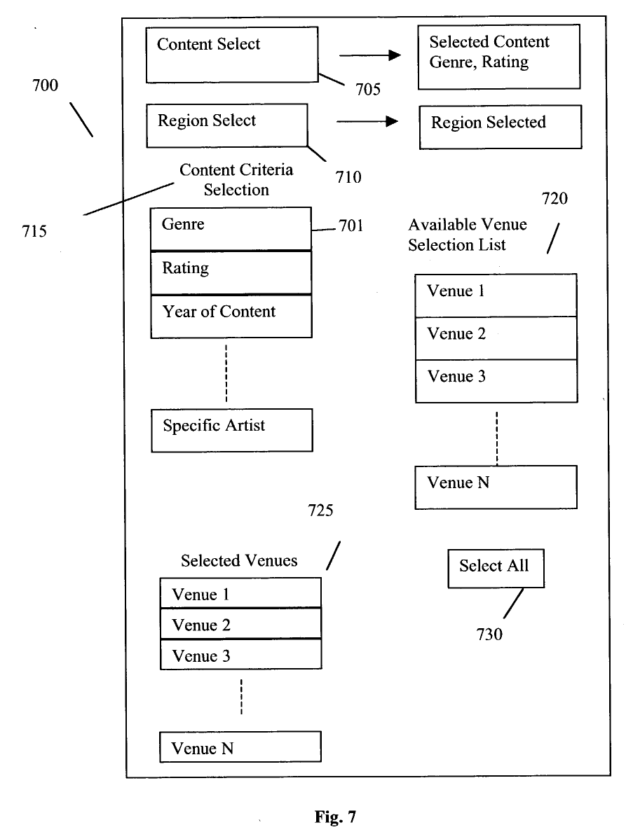

FIG. 7 illustrates one embodiment having menu 700 that a user can use to select jukeboxes that allow content to be played based on availability for content criteria (i.e., genre, ratings, region selected, etc.). In this embodiment, a user first selects either content desired to be played (from content select 705), or content criteria (content criteria select 710). Next, the user selects a zone (city, country, state, etc.) via region select 715. The user selects content criteria, for example genre 701, from menu 700 on display 210. Controller 220 then determines the available jukeboxes on a network that the content can be played on based on content criteria, i.e., ratings, genre, year, allowed artist, etc. For illustration purposes, FIG. 7 shows genre 701 darkened to illustrate that genre 701 is currently selected. A genre list (e.g., genre list 493 in FIG. 4C) would be displayed allowing a user to select the desired genre. When the desired genre is selected, a song listing (in alphabetical order) is displayed. The user can choose between artist and song title for searching, or the user can use a text searching feature through user interface 240. The user can then select any or all (from select all 730) of the available jukeboxes to play the content on through available venue selection list 720. The selected venues would then be displayed on selected venue list 725.

Once the user has selected the number of jukeboxes to play the content on, the user selects how and when the content is to be played (i.e., simultaneous, staggered, etc.) through a menu on display 210 (not shown). Controller 220 then determines the cost to play the content selected at the desired jukeboxes, at the desired time(s). Controller determines the cost by looking up prices stored in memory coupled to the controller. That is, first there is a fee for number of plays. Then there is a fee based on how the content is to be delivered (i.e., staggered, simultaneous, FIFO, etc.). The user then can see the cost involved on display 210 before accepting the charges. If the user determines the fee is too high, the user can adjust his/her selection to lower the cost. It should be noted that selection of genre specific jukeboxes on a network can also be selected for play from a remote device.

One feature of using criteria selection to list available venues is that users can use the genre selection to determine which venues may be suitable for them to visit. They can also pay a fee and turn on a camera at the venue to see what is going on there. In this manner, users can use a jukebox system 200 to determine a venue to visit in the future. Also, artists that create music/video in a specific genre can target venues that cater to the same genre. Professional marketers or record labels can also benefit by using the genre specific feature. Also, marketing professionals can use the genre selection to build marketing lists for products that may be targeted to individuals that may prefer a certain genre over others (e.g., commercials can be selected for country music genre venues for selling country western wear; commercials for rock concerts can be played at rock and roll genre specific venues, etc.). In one embodiment, a user can select a venue from a menu and get information regarding the particular venue. Therefore, a summary, prices, calendar of events, food menus, pre-recorded images, commercials, etc. can be displayed either remotely or through display 210. Thus, jukebox system 200 can assist users in finding venues that suit their criteria. And, if the venue has a camera(s) coupled to a jukebox system 200, the user can actually see the venue, and what is going on there remotely.

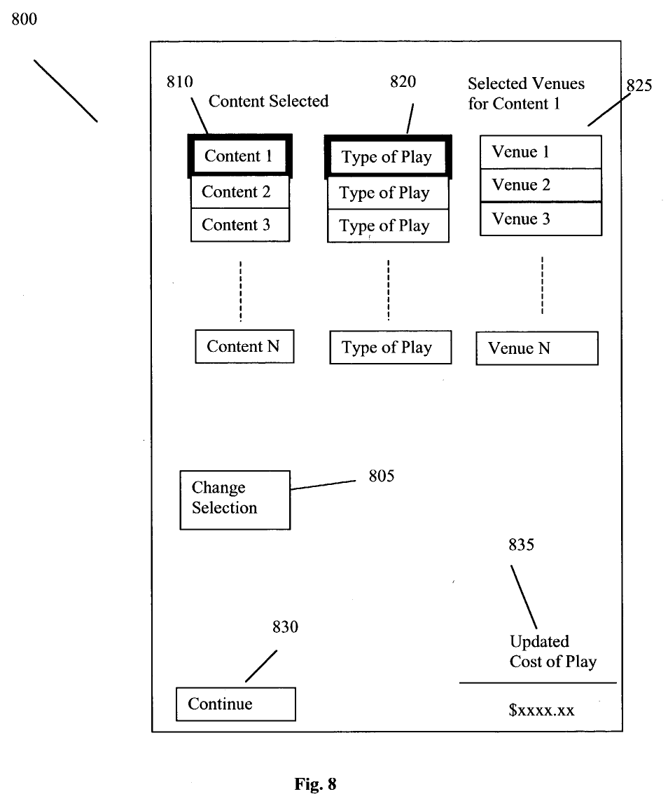

FIG. 8 illustrates one embodiment where after the cost is displayed on display 210, a user can select a box that assists the user in lowering the cost. In this embodiment, menu 800 is displayed on display 210. Once the menu is selected, a user is given text information on how to lower the costs. The user can then select different combinations and view the cost on display 210. Once the user is satisfied with his/her selection, the user can then select “continue” 830 and submit the correct fee or use a credit or debit card to pay for the selection. It should be noted that content selected can be any content, e.g., song, video, camera selection, commercial, text, etc. A user can thus select change selection 805 and select content to delete/add. The user's selected content is displayed (illustrated as the content list 810). For example, FIG. 8 shows content 1 selected for possible change. Type of play selection 820 is regarding the type of play, i.e., staggered, simultaneous, high priority, etc. List 825 illustrates the selected venues for content 1. The updated cost is displayed at updated (i.e., current selection) cost 835. In one embodiment, automatic changes can be determined by jukebox system 200 based on selected fee input (not shown). In this embodiment, the user selects the fee he/she is comfortable with, and controller 220 determines possible combinations that may appeal to the user. The user can then select the option that most appeals to the user.

In one embodiment, the simultaneous playing of content at a plurality of different venues having jukebox systems coupled to the network is arranged based on time and priority. In this embodiment, controller 220 (in each jukebox system), receives information in a header of a stream(s) of data or a packet(s) or file(s) that allows controller 220 to determine the content is to be played substantially simultaneously (as close as possible) at other venues. In this embodiment, controller 220 organizes (i.e., places in order) content that is already selected for play based on priority and timing. Content selected to be played simultaneously will be adjusted to a higher priority (e.g., in a selected content queue). The controller will raise the priority and play the content selected for simultaneous play in order to play the content at or near the selected time for simultaneous play. In one embodiment, a user can select a time for play in advance from a remote location from where the user accesses a website coupled to the network, such as the Internet. In this embodiment, controller 220 can schedule the content to play at a particular time, and thus set a high priority and time for which to play the content.

In one embodiment, content selected for simultaneous play at a plurality of venues is played at a particular time selected by a user. In this embodiment, content that is being played is stopped and rescheduled after the simultaneous selected content has completed playing. In this way, a user that had selected content to be played will still be able to have his/her content played in full, albeit a delayed time. In one embodiment, the current playing content will fade out slowly before the simultaneous content is played. In one embodiment, a message will be displayed on display 240 (and or display 210) where the simultaneous plays are occurring. In this embodiment, a message will also be displayed alerting that the last played song that was interrupted will be replayed in full after the simultaneously selected content is played. In one embodiment, a message can be displayed on one of the displays to inform patrons of how many venues the content is being played at.

In one embodiment, jukebox 200 can transmit images from camera 295 (or more cameras 296) to other venues. In this embodiment, a user can select images be sent to other venues after depositing funds (or paying via credit card or debit card) in jukebox system 200. If there are no other content being played at the selected venue for transmitting images from camera 295, the images are streamed through the network to the selected venue having a jukebox system coupled to the network (i.e., if only audio is being played, and the display is not showing other scheduled content, such as video only commercials, then the images transmitted from the cameras can be displayed, if allowable at the specific venue. Since content allowability is determined by an owner or manager of the particular venue, images can only be sent to jukebox systems that allow images to be received. In one embodiment, the images are sent substantially in real-time (dependent on bandwidth availability, etc.). In another embodiment, the images are buffered and sent in delayed files or packets. In this embodiment, buffering allows for smoother imaging to be viewed at the selected venue. For example, 30 seconds of imaging can be buffered. Then, while the next 30 seconds is being buffered, the previous 30 seconds of imaging can be displayed on a display 290 coupled to jukebox 200.

In one embodiment, camera images can be transmitted from one jukebox system to a plurality of other jukebox systems that are coupled to the same network. In an embodiment having a plurality of cameras (i.e., cameras 295 to camera N 296), a user can select which cameras to transmit images from. That is, a user can either select a certain period of time for which to transmit images from a desired camera, or can, in real-time, select which camera to transmit images from. This comes in handy when a venue has more than one camera coupled to a jukebox system 200. A user can also dynamically select which camera to view from. For example, if a user is watching a particular individual, and the individual moves out of the current camera's view range, the user can select another camera (if available). If the person that the user wanted to see is now in the range of the newly selected camera, the user can maintain the current selection. If not, the user can try another camera. In one embodiment, a zoom function is available on a camera, such as camera 295 or 296. In this embodiment, a user can select to zoom in to the camera's available zooming distance. The camera selection functions can be made through the user interface or from a remote device (such as a remote control).

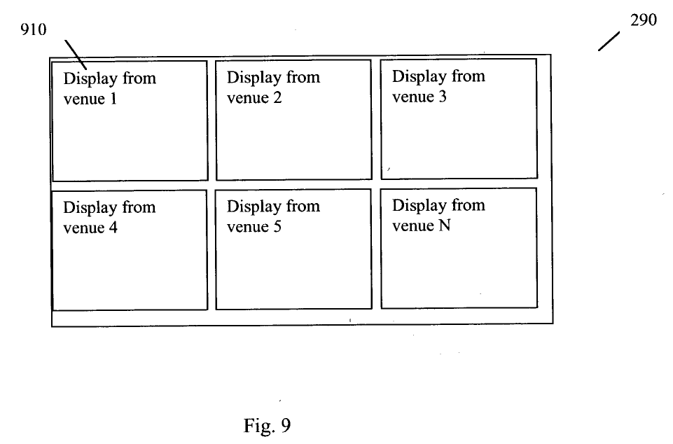

In one embodiment, a user can select from any venue to transmit camera images to another desired jukebox system coupled to the network. In another embodiment, a user can select multiple venues from where to transmit images to any desired venue having a jukebox system coupled to it in a desired format. FIG. 9 illustrates that a desired format can be images adjusted to simultaneously fit on display 290 together that are from each venue (i.e., a plurality of squares where each square 910 is an image from a different camera location). Another format can be a full-screen image from a camera location at a venue having a jukebox system coupled to the network, where the full display is switched at a desired interval (i.e., every ten seconds, every 15 seconds, etc.), in succession. It should be noted that each jukebox system coupled to the network each has a particular venue identification code, number or fixed IP address. In one embodiment, a user can select the desired order of display of images transmitted from other venue jukebox systems. In another embodiment, controller 220 selects images by jukebox system identification number order (e.g., higher to lower, lower to higher, alphabetical, etc.). In other embodiment, other combinations are selectable. In one embodiment, a user can select and view images from a remote device (such as a PC coupled to a network). Therefore a user can view images from one or more venues to check on people attending, (e.g., how crowded a place is). Also, a user may desire to view a venue during special celebrations, e.g., New Year's Eve, St. Patrick's Day, Fourth of July, etc.

In one embodiment, audio device 280 comprises at least one sound signal amplification device and at least two speakers. In another embodiment, audio device 280 has a sound processor (e.g., such as a surround sound processor) coupled with a sound signal amplification device. In these embodiments, audio device 280 allows audio content to be played at a venue where jukebox system 200 is situated. It should be noted that any type of speakers, amplifiers, etc. can be used to play audio content from jukebox system 200. It should also be noted that any number of amplifiers and speakers can be added that are compatible, and that are suitable for the specific venue.

Output router 200 selectively distributes content based on the type of content. That is, output router 200 distributes audio content to audio device 280 and video/graphic/text content to display 290 through a graphics device, such as a graphics card. Known types of computer graphics and sound cards can be used with jukebox system 200. In this embodiment, router 200 is similar (or the same) to the way a computer (e.g., a personal computer (PC)) routes video/graphics/text to a graphics card, and audio to a sound card.

In one embodiment, a user can remotely log on to a website by entering a user identification and password to upload content. In this embodiment, a user can upload content that is desired to be played on any or all of the available jukebox systems that are coupled to the network. In this embodiment, the content is transmitted to a third party for rating the content according to any standard audio/video rating system. Once the content is rated, the user can select available (i.e., jukebox systems allowed to receive the specific rating, genre, etc.) jukebox systems for which to play the content. The user can select any/all jukebox systems at different venues to play the content, and can play the content in either a staggered or simultaneous fashion at the selected venue(s). With this feature, an independent artist that cannot typically have his/her music played on a wide basis (i.e., radio or televised, such as VH1™, MTV™, satellite audio, etc.) can distribute his/her music/video at many venues where jukebox systems are located that are coupled to the network. Also, record labels can use this feature to promote their own artists in addition to, or in lieu of, radio play. Seeing that a record label may have more available funds than an independent artist, in one embodiment, a program scheduler running on a server coupled to the network where jukebox systems (such as jukebox system 200) are coupled, limits users to how much content, and how often content can be played simultaneously at a plurality of different venues where the jukebox systems are coupled to a network. In this embodiment, the scheduling process keeps track of when a user (such as an independent artist or record label) last played content simultaneously. The scheduler can then determine when the next available time slot and date for which that particular user can submit content to be played simultaneously. Various schedules can be used, depending on how many simultaneous selections are made on the system. Therefore, scheduling can be dynamic. Thus, if there are no scheduled simultaneous plays for a specific day, a user will then be allowed to select to play content simultaneously accordingly. In another embodiment, a predetermined number of simultaneous content play selections are allowed for a set period, such as per week, per month, per quarter, etc.

In one embodiment, newly uploaded content that has been rated is played simultaneously according to normal simultaneous content playing scheduling (i.e., priority and or time and priority availability). In one embodiment, priority can be changed based on cost. In this embodiment, a user can pay more funds to advance the priority of selected content to be played on one or more jukebox systems located at a plurality of different venues (i.e., a user can raise the priority over other equal prioritized scheduled content). It should be noted that emergency content is always the highest priority and cannot be overridden. In one embodiment, a user located at a particular venue having a jukebox system (such as jukebox system 200) that schedules (i.e., selects content to be played), has a higher priority than a user that selects to send content to the venue from another venue. In another embodiment, the name of the artist and song title (in the case of audio content) is displayed on display 290 and/or display 210. In another embodiment, the artist name and song title is announced through audio device 280.

In one embodiment, content is played simultaneously based on statistical data from any/all jukebox systems coupled together on a network at a predetermined or random based event. In this embodiment, for example, the number one played (i.e., most selected) content can be played simultaneously at all available venues having jukebox systems coupled to a network at a predetermined time. In another choice, a random number generator (e.g., any standard random number generator; the seed can be time) can select a time at which to play the number one selected content. With this feature, content played the most will get a benefit or bonus of being played simultaneously at all available jukebox systems coupled to the network.

In one embodiment, when no content is selected to be played at a jukebox system (such as jukebox system 200) coupled to a network at a particular period, content is downloaded from a content server coupled to the network and all jukebox systems. In one embodiment, the content from the content server comprises audio and/or video commercials. In another embodiment, instruction or capability information for the jukebox system is played on a display at a particular venue having an open schedule. In one embodiment, the audio and or video commercials are downloaded to all available jukebox systems coupled to the network at a predetermined time. In this embodiment, the content server operator can transmit a delete command or a “no play” priority code to attach to the content when the content is no longer desired to be played by the author (i.e., when the author does not desire to pay for playing the content anymore). Therefore, when no content is scheduled, controller 200 has a process that performs a search of commercials available for play. The process will skip over all commercials with a “no-play” priority (e.g., −1 priority, where normal priorities may range from 0 to 10). All other commercials will have a normal priority assigned to them if still available for play. In one embodiment, all content that has an assigned “no-play” priority, will be deleted from memory. In one embodiment, when no selections are scheduled to play currently, random content can be played on a jukebox system. In this embodiment, visuals from other locations, content from other locations, etc. can be played.

In another embodiment, the audio and or video commercials are downloaded to all available jukebox systems coupled to the network during a time when it is determined that no content is selected to be played. The features of playing commercials on jukeboxes allow product/service companies to reach a broader audience, and also allow a jukebox system owner to increase income. And, content not normally allowable through televised or radio advertisements may not be illegal (e.g., alcohol, cigarette, adult content, etc. commercials or advertisements). In another embodiment, commercials can be played on available jukebox systems (note that availability is up to the venue owner/operator) based on priority, which is based on payment. That is, if higher payment is received, commercial content can be played ahead of scheduled content.

In one embodiment any jukebox system 200 coupled to the network can act as a content server to other jukebox systems coupled to the network. Therefore, if a user selects to have content played at another jukebox system 200 in the network, the jukebox system acting as a server can transmit the desired content (file, packet, stream: having venue code in a header or file) to any desired other jukebox system(s).

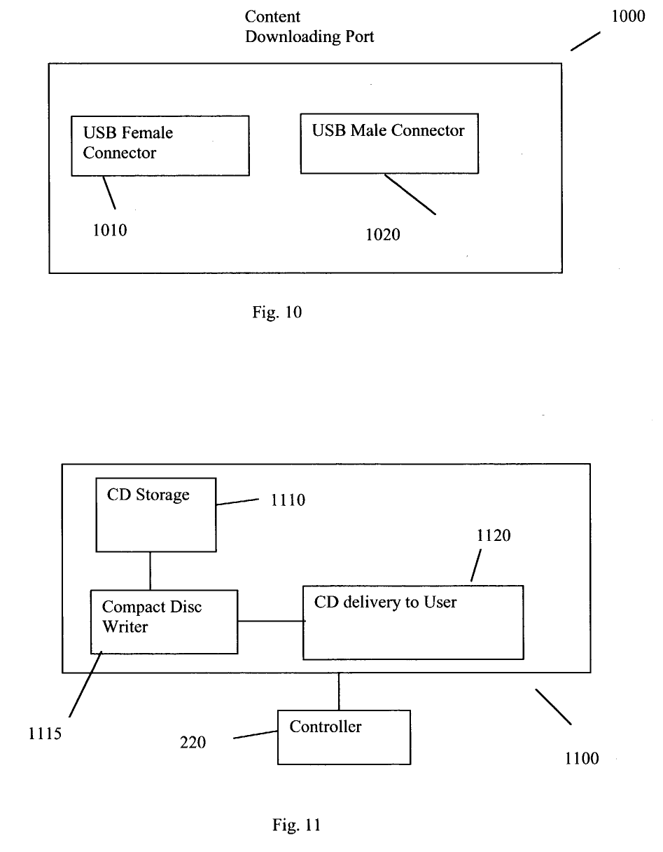

FIG. 10 illustrates one embodiment where jukebox system 200 further includes content downloading port 1000. In this embodiment, content can be downloaded or transferred to a remote device from jukebox system 200 (either directly form memory or from the network to the jukebox system to the remote device). In one embodiment, the remote device is an MP3 player/recorder. In this embodiment, a standard connector, such as USB female connector 1010 and USB male connector 1020 are coupled to the loading port. In this embodiment, the standard connectors can be a retractable USB cable (i.e., a replaceable standard or metal covered cable), a wireless content delivery mechanism, or a male/female fixed connector. In this embodiment, a user can select and download content to the player/recorder from a jukebox system 200. One should note that even if jukebox system 200 may have ratings limits (i.e., rating, genre, etc.), all content is available to be transferred to a recorder/player since the content would not be played at the venue.

FIG. 11 illustrates one embodiment where jukebox system 200 further includes compact disc writer 1115, compact disc feeder (not shown) and CD delivery device. In this embodiment, content is selectable and copied/written onto a clean compact disc. The disc is then delivered to the user. In this embodiment, a user can create desired CDs for a fee. In this embodiment, a standard type of CD replicator/duplicator can be employed within jukebox system 200. These typical devices write content to a CD, label the CD, and package the CD in a jewel case (or other type of case). In this embodiment, a delivery system transports the completed CD to a retrieval area (not shown). The user can then retrieve the completed CD. By using this embodiment, the moneys collected can be distributed to the artists on an agreed upon fee. One should note that even if jukebox system 200 may have ratings limits (i.e., rating, genre, etc.), all content is available to be written to a CD since the content would not be played at the venue. The information for the written content is transmitted to a server having a database for written content. The database keeps track of which songs are downloaded in order for the artists to be paid the royalties due to them. Different means can be used to pay royalties owed, such as automatic money transfer to different accounts, once a month or quarter accounting, etc.

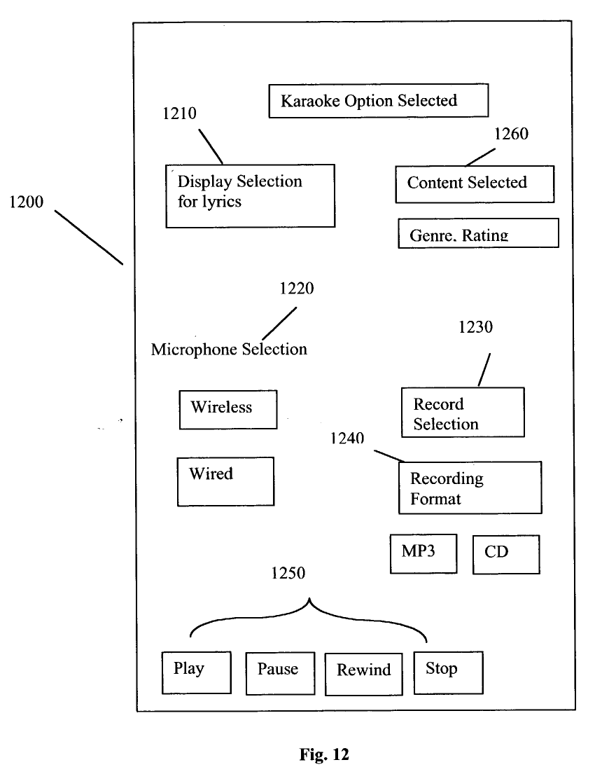

FIG. 12 illustrates one embodiment where a karaoke selection can be made on jukebox system 200. In one embodiment, a sound filter is used to filter out a vocal portion/tracks of content. Therefore, a user can sing along to content with their own voice. Typical karaoke systems do not always use the original artist's music. That is, the typical karaoke system has a different version of the music. In these embodiments, the actual music of the artist is used, albeit missing the vocal tracks. Typical karaoke devices, such as wireless microphones, can be used with the system. In this embodiment, jukebox system 200 includes an amplification device to play the signals received from the wireless microphone in proportion to the content play volume. In another embodiment, lyric content are associated with each content file. In this embodiment, a user can read lyrics on one of the displays coupled to jukebox system 200. In this embodiment, when karaoke selection is made from the user interface, content is played without the content's vocals. In one embodiment, a sound filter device is included in controller 220. Known vocal filters can be used in controller 220. In these embodiments, jukebox system 200 obviates the need to have a karaoke disc jockey present, and also obviates the need for specialized karaoke equipment. In another embodiment, separate content having vocal tracks removed is used instead of content having vocal tracks when the karaoke option is selected. Therefore, many available content is stored in pairs (i.e., content with a vocal track, and content without a vocal track). In the above karaoke embodiments, a user selects content to be played and only has to select the karaoke option via menu 1200. If a venue has additional karaoke equipment (such as wireless microphones, wired microphones, etc.), this equipment couples to a jukebox system through an audio input channel and is amplified along with the content.

In one embodiment, a user has play control over the karaoke content selected through control selections 1250. In this embodiment, a user can play, stop, rewind or pause play of the content. In one embodiment, a wired microphone is coupled to jukebox system 200. The wired microphone has a limited extension capability. For example, a retractable microphone cord can be 6 feet-12 feet long. If wireless microphones are selected (from microphone selection 1220), jukebox system 200 can receive and amplify signals received from the wireless microphone, and the wired microphone would be turned off. It should be noted that both wireless and wired microphones can both be used simultaneously when more than one person is singing. Also, multiple wireless microphones can be used as well. In this embodiment, jukebox system 200 is limited to microphone channels. For example, jukebox system 200 may have 3-6 channels available for microphones.

Menu 1200 also includes display selection for lyrics 1210. Through this selection, a user can select where to display lyrics. Therefore, a user can display the lyrics on the jukebox system display 210, or display(s) 290 (or not at all). Menu 1200 also allows a user to record the song through record selection 1230 with the user's voice on either a CD or in an MP3 file (or other format) for downloading. Therefore, a user can have a recording of their own voice with an artist's music. The user selects the type of format through format selection 1240. Selected content information is displayed as well (content information 1260). In one embodiment, other information relating to the selected content can also be displayed, e.g., trivia, history, etc.

In one embodiment, a user must enter a username and/or password if more than one user are using the karaoke feature. In this embodiment, each user takes a turn in a cycle. This feature is used when a venue uses jukebox system 200 for a karaoke night where multiple users take part in the event. In this embodiment, when it is the user's turn in the cycle, the jukebox system has the username associated with content to be played for the specific user. Therefore, the system pauses and sounds out the user's username in an alerting message so the user knows it is their turn in the cycle. The pause can be set by an owner/manager for a predetermined amount of time (e.g., 30 seconds to 3 minutes), or manually for as much time as necessary. If user's have multiple entries in the cycle, jukebox system 200 arranges the karaoke content queue in a round robin fashion. That is, the queue will place redundant users after the end of the cycle. The system traverses the queue until a username is repeated. The repeated username is temporarily removed and placed in memory with its associated content. In one embodiment, the content remains associated by using a pointer to the address of the content. In another embodiment, association is done by using a header including the username that is attached to the content file. After the content is played, the copy of the content file is deleted from memory, while the original content file remains. The queue is traversed again until there are no more redundancies. Then the temporarily stored content is placed at the end of the queue in the same order the content and associated username was temporarily stored in memory. In this fashion, no users will miss a turn unless they want to be skipped. In one embodiment, a skip selection (not shown) is used to skip a user's turn. With the skip selection, a user can skip back any number of places or to the end of the list (i.e., before the next redundant user). With this feature, if a user cannot make his/her turn due to a telephone call, eating food, ordering drink or food, going to the restroom, etc., the user can delay their turn appropriately.

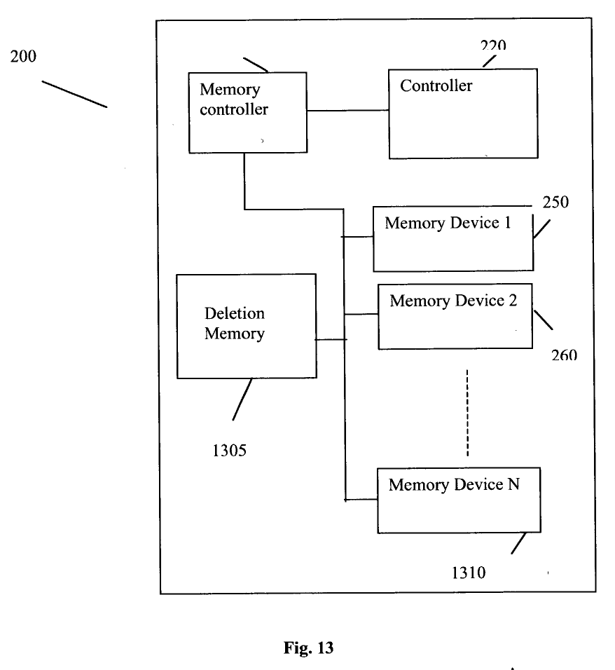

FIG. 13 illustrates one embodiment wherein if content stored in memory on jukebox system 200 is not played for a predetermined amount of time (e.g., two months, three months, etc.) or selected amount of time (i.e., by a owner/operator/manager), a memory controller within controller 220 commands contents to be transferred from a memory device (such as memory device 250, memory device 260, or any other number of memory devices (e.g., memory device N 1310) coupled to controller 220) to a deletion memory device 1305. Deletion memory device 1305 stores content that a manager/owner/operator of a jukebox system 200 may want to delete. In one embodiment, content stored on memory devices other than the deletion memory device cannot be deleted by an owner/operator/manager of the jukebox system. Content on the non-deletion memory devices can only be deleted by a service provider or special authorization. This feature is included to prevent accidental deletion of content. An owner/operator/manager of a jukebox system can decide whether to delete content from the deletion memory device or not. If content stored on the deletion device is selected for play, the memory controller will transfer the content back to a non-deletion memory device.

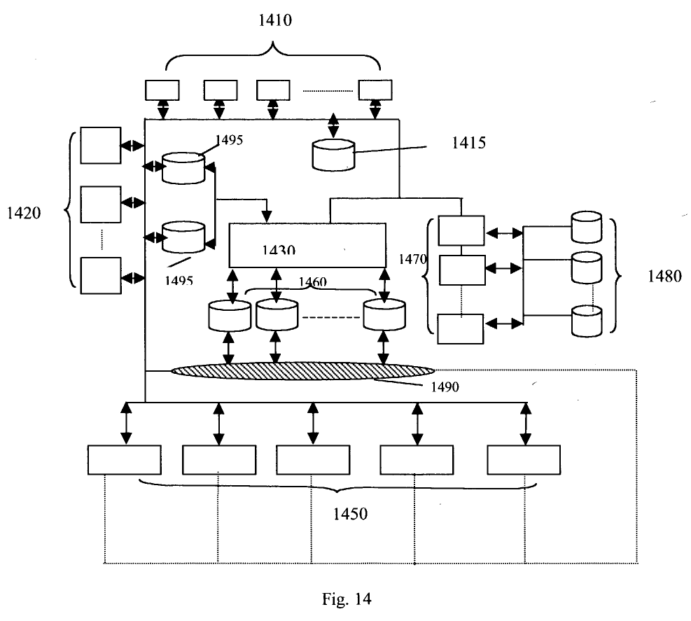

FIG. 14 illustrates multi-way jukebox system network (JSN) 1400. JSN 1400 includes a plurality of multi-way jukebox systems 1450 (e.g., a plurality of jukebox systems 200), a plurality of remote user connections 1410, a plurality of remote manager and/or owner connections 1420, at least one personal user data server 1415, at least one master controller 1430, a plurality of content servers 1480 coupled to a plurality of content managing processes 1470, a plurality of content routers 1460, a plurality of management servers 1495, and network 1440. Transmission media 1490 can be any transmission/receiving means, such as satellite, DSL, telephone lines, etc. that can transmit/receive content packets and data to/from jukebox systems 1450. It should be noted that all the above embodiments of jukebox 200 can be used in JSN 1400. In one embodiment, JSN 1400 includes a firewall program to protect the servers from unauthorized access.

In one embodiment, all content that is transmitted or received by jukebox systems 1450 is sent/received as stream, packets or files (e.g., MP3, MPEG, etc.). Each data type transmitted or received includes identification (ID) of a jukebox system in order to differentiate each jukebox system from one another. Identification can be in the form of a code or number that is specific to one particular jukebox system that is coupled to network 1440. For example, a unique serial code of each jukebox system 1450 can be used as the ID code. In another embodiment, the ID code can be based on location, such as country, state abbreviation, a number representative of a city, and a unique number (e.g., US-CA-1010-99999). In another embodiment, the ID code is a fixed IP address. In one embodiment, the ID code can be encoded and placed in a header of a transmission/receive packet or in a content's file. The ID code is associated with various venue specific information (e.g., associated fields in a database, etc.). The specific information can include: country, state, city, county, limitations (i.e., ratings, genre, etc.), equipment available, street address, etc.

In one embodiment, the ID code is stored in a database on content servers 1480. Associated with each jukebox 1450 ID code stored on servers 1480, are privileged availability, such as allowable rating (and parental controlled terms list), genre, video, cameras, connection to network, etc. The ID code for each jukebox system 1450 is also stored on management servers 1495. Associated with each jukebox system 1450 ID code stored on management servers 1495 are statistics for content played on any/all jukebox system 1450. The associated statistics contained on management servers 1495 are statistics for how many times each content has been played, top 10 (or other top number) content that has been played, how much fees have been submitted for a time period (such as the last twelve months, month, day, etc., and totals), etc. Also stored on management servers 1495 are overall statistics for JSN 1400. This includes at least each specific content play total, top charting (such as top ten, etc.) content played overall, total fees collected, organization of jukebox systems 1450 by region, area, state, city, country, county, etc., fees to be transferred to publishers, etc.

Remote user connections 1410 can be any number of connections available on network 1440 (e.g., the Internet). A user uses a user connection 1410 to access a website where personal information can be stored, such as personal content selection lists, etc., on a user data server 1415. A user can upload content for play at available venues (after the content is rated) through a user connection 1410. A user can schedule content to be played and view content statistics through user connection 1410. A user can connect to the website remotely anywhere the network can be accessed. Each user has a unique username and password in order to logon to the website and access/amend the user's personal data.

Managers or operators can access management data through remote manager connections 1420. Management data, such as statistics, fees paid to publishers, fees owed, etc. can be viewed through remote manager connections 1420. Managers/operators can select ratings limits, genre limits, camera limits, etc. through remote manager connection 1420 by accessing a website on the network. Each manager/operator has a username and password that allow access to their specific jukebox system characteristics. A data packet containing jukebox characteristics (e.g., ratings limit, genre limits, camera availability, etc.) is stored on at least one of management server 1495. The characteristic packet is then transmitted by master controller 1430 to the specific jukebox system 1450. Each jukebox system receives the characteristics packet and applies the limits/controls to the jukebox system.

Master controller 1430 performs scheduling, communication to managers/operators/users/servers/etc. of JSN 1400. Master controller 1430 keeps track of ordered content to be played at various venues, schedules and delivers content to each jukebox system 1450. Master controller attaches information in the contents packet/file/stream for scheduling content selected to be simultaneous played at specified times/dates. The file/stream/packet has a priority and time/date of scheduled play attached. As the content is delivered to each jukebox system 1450, the jukebox system's controller arranges the content to be played as requested based on the priority and time/date stamp. It should be noted that the identification code is used by master controller 1430 to route the packet/file/stream to the specific jukebox system(s) the content was ordered to be played on.

Master controller 1430 is capable of determining the type of network connections that each jukebox system 1450 is coupled with. When each jukebox system 1450 is installed at a venue, the type of connection(s) are known (i.e., satellite, cable, DSL, etc.). This information is recorded onto management server(s) 1495 (e.g., a specific code for the type of connection, such as 1 for satellite, 2 for DSL, 3 for telephone, etc.). Master controller 1430 then can transmit data/content to the specific router 1460 for the delivery of the content/data to the jukebox system(s). Therefore, if content/data is to be sent to multiple jukebox systems 1450, where each have different network connection type, master controller 1430 would route the content/data to multiple routers 1460 (i.e., to each router coupled to each specific type of network connection).

Content servers 1480 are used to store content, statistics (e.g., number of times content played per venue/overall, moneys paid/collected, etc.), menu screens, etc. Content managing servers 1470 provide updates to jukebox systems 1450, user connections 1410 and management remote connections 1420. These updates can be newly added content, newly added statistics, newly added venues, etc. Content managing servers 1470 provide encryption of content. In one embodiment, content is stored on content servers 1480 in encrypted form. In another embodiment, content-managing servers 1470 encrypts the content as it is transmitted to a jukebox system. In these embodiments, each jukebox system 1450 decrypts the content so the content can be played at the venue. Master controller arranges the encryption and changes the keys often in order to protect the content from unauthorized access. Standard encryption techniques known to those skilled in the art can be used.

In the above embodiments, master controller 1430 is a process or program that runs on a server. It should be noted that the term server includes various computer systems. It should also be noted that while FIG. 14 illustrates separate server systems, it is possible for all servers to be located on one server system (i.e., one computer having multiple CPUs). It should be noted that when a user submits new content to be played on a jukebox system 1450, the content is transmitted on network 1440 to a rating service (not illustrated). The rating service is an outside authority on standard content rating. The rating service returns a rating code for the content and master controller 1430 attaches the rating code to the content's packet/stream/file in a header. The rating code can be a rating identification code, such as 1 (General rating), 2 (Parental Guidance), 3 (Restricted), etc. It should be noted that a genre identification code is also attached to a header in the contents file/packet/stream, e.g., 1 (classical), 2 (rock/Pop), 3 (Country Western), etc. Therefore, the header in each packet/file/stream has enough depth (i.e., bits) to hold the necessary information regarding the content (i.e., rating, genre, destination, priority, etc.). In one embodiment, the packet/stream/file header is at least 32 bits wide. In other embodiments, the packet/stream/file header can be expanded to allow more information to be stored (e.g., 64 bits, 128 bits, etc.).

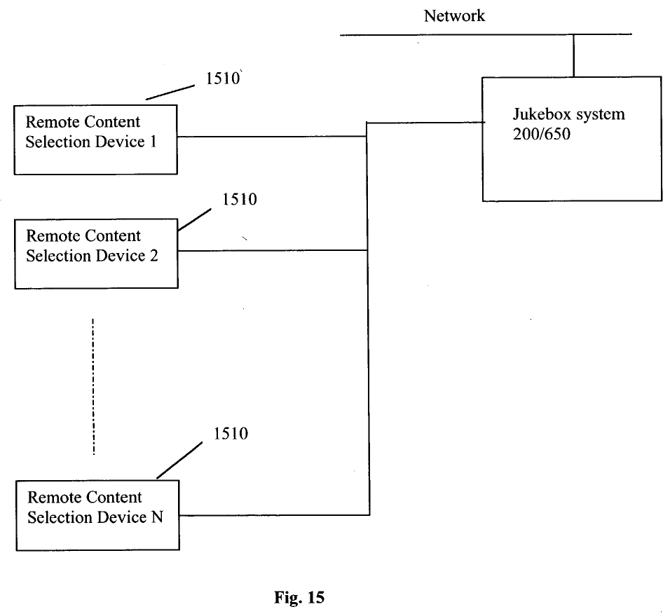

FIG. 15 illustrates one embodiment where each venue having a jukebox system (such as jukebox system 200/1450) may use remote desktop units that are connected either by a typical wire connection or through wireless routing hardware. Desktop units 1510 transmit/receive information from the jukebox system located at the same venue. This embodiment works similarly to remote terminals that are coupled to a base computer. Each remote desktop 1510 unit is of the size to enable them to fit well on a bar, table, wall, etc. The remote desktop units communicate with the associated jukebox system and act as user interfaces (including display) to users. By having remote desktop units, more users can access the jukebox system or jukebox network, simultaneously. Thus, orders for content can be made simultaneously by more than one person located at the venue, which helps user's to enter their selections quicker since they do not have to wait for another to finish if a remote terminal is available.

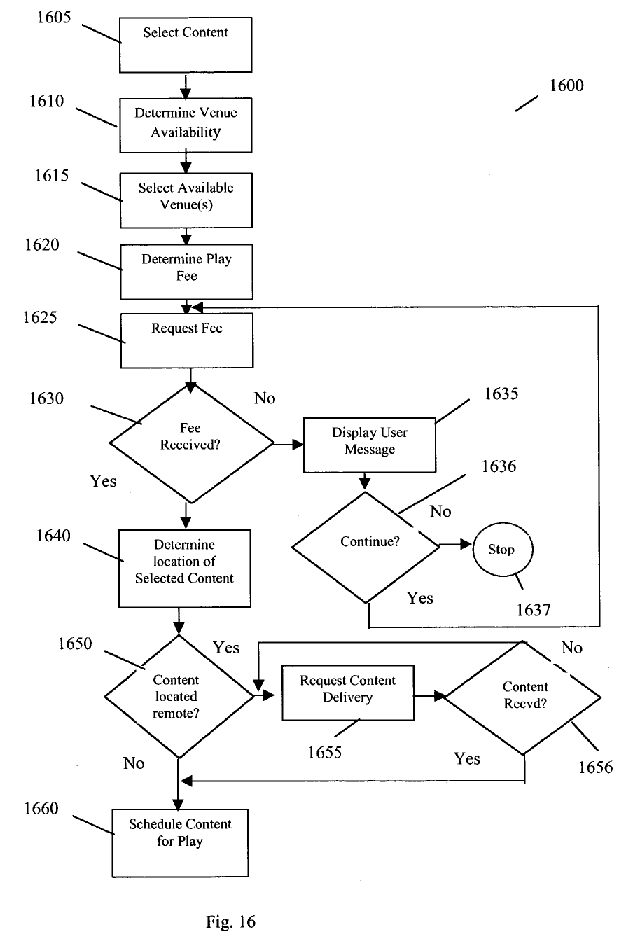

FIG. 16 illustrates a process for selecting content to be played on one or more jukebox systems (such as jukebox system 200/1450) in a network. Process 1600 begins with block 1605. In block 1605, content is selected by a user to play on at least one jukebox system in a jukebox system network (such as JSN 600). The content is selected through a user interface on a jukebox system or from a remote connection. After the content is selected, process 1600 continues with block 1610. Content is arranged in menus on a display coupled with a jukebox system. For personal user selections, the user would login through the user interface and the user's personal selection list would be displayed on a menu on a display coupled with a jukebox system. For non-personal selections, a user can select from a variety of menus that are organized by a choice of: genre, year range, chart listings (overall, venue specific), user search result, alphabetical, recently released albums/songs, independent artists, karaoke, videos, camera transmission, content currently playing or scheduled to play at other venues, etc.).

In block 1610, venue availability is determined by jukebox system characteristics (i.e., ratings limits, genre limits, network connection, etc.). The selected contents rating and genre are compared with all the jukeboxes currently connected in the network. The available jukebox systems are then displayed for a user to select from on a menu on a display coupled with the jukebox system. Process 1600 continues with block 1615, where a user selects one or more of the available venues for which to play the selected content. Process 1600 continues with block 1620. A user also selects priority (the priority effects price) and type of play (i.e., simultaneous if more than one venue, time, etc.).

In block 1620, the fee is determined for the selected content based on number of venues, priority, simultaneous play, etc. Once the fee is determined, block 1625 displays a message to the user informing the fee amount required. The user deposits fees, uses a credit card/ATM debit card, or uses a personal account that has credit (i.e., a revolving credit account, associated debit card replenishment, etc.). Process 1600 continues with block 1630, which determined whether the correct fee is deposited/verified. If block 1630 determines that the required fee is not received or not verified, block 1635 displays a message to the user requesting the required fee, change selection, etc. Process 1600 continues with block 1636 where the user selects whether to continue with the transaction or not. If the user selects to continue, process 1600 continues with block 1625. If the user selects not to continue, process 1600 stops at block 1637.

If the correct fee is received/verified, process 1600 continues with block 1640. In block 1640 it is determined where the content is located (i.e., on the specified jukebox system(s), or on a server. Block 1650 determines if the content is located remotely to the jukebox system(s). If the content is located remotely, block 1655 requests the content to be delivered to the necessary jukebox systems. Block 1656 determines whether the content has been received. If block 1656 determines that the content has not been received, process 1600 continues with block 1655. If block 1656 determines that the content is received, process 1600 continues with block 1660.

In block 1660, the content is scheduled for play. If the content is to be played simultaneous at various venues, a master controller attaches a priority for simultaneous play, which overrides other priorities except for emergency content. If the content is to play on jukebox systems without a simultaneous play request, the master controller assigns a priority for the content. The specific venue where the content is to play schedules the content in memory based on the priority as compared to already scheduled content and their specific priorities.

In order for the content to play on a jukebox system, the content is either converted to video signals that are displayed on a display, converts the content to audio signals and transmitting the audio signals through an output device (such as an amplifier and through speakers), or both (in the case of a music video or commercial, etc.).

Process 1600, except for user input necessary, can also be stored on a device or medium and read by a machine to perform instructions. The device or medium may include a solid state memory device and/or a rotating magnetic or optical disk. The device or medium may be distributed when partitions of instructions have been separated into different machines, such as across an interconnection of computers.

It should also be noted that jukebox systems, such as jukebox systems 200/1450 can be enclosed in a unit that is no bigger than a typical CD based jukebox system. In many cases, the packaging of a jukebox system can be much smaller as the additional room that a CD based jukebox system uses for holding a plurality of CDs is not necessary. It should be noted that the enclosing structure is a design choice. Also, security features (i.e., locking mechanisms and added reinforcement) are included in the above embodiments to protect against tampering and unlawful taking of monies or other items included in a jukebox system.

In one embodiment, motion sensors can be coupled with jukebox system 200/650. The jukebox system can be placed in a silent mode, i.e., lights and sound are off while the controller or CPU and other components are operating. In this mode, if a motion sensor detects motion, the jukebox system can turn on cameras and transmit video signals to a remote server. In another embodiment, the cameras can transmit video to law enforcement or private security companies. Therefore, the jukebox system can also act to help prevent crime or to give video of unlawful entry, etc. In one embodiment, the motion detectors are located with the camera and track the motion while transmitting video. A security or law enforcement agent can log on remotely to the network and use the camera control features. This feature can assist law enforcement agencies to apprehend criminals by the use of the video files for evidence or real-time crime prevention. The owner or operator can use a secure code to turn on/off the security feature, either remotely or at the venue (i.e., via a remote control device or manual entry through the user interface). In one embodiment, this security feature is only active when the secure code is entered and the security feature is turned on.

With the multi-way capability of jukebox systems 200/1450 in a network, artists, labels, etc. can now have a means for distributing their respective content simultaneously, staggered, scheduled, etc. at a number of jukebox systems coupled in the network. And, the content play at any jukebox system in the network can be ordered from any jukebox system or remotely coupled user to the network (i.e., a computer coupled or logged on to a website, etc.). New artists or independent artists, companies wanting commercials broadcasted in a limited range (i.e., less expensive), etc. can now have the ability of having the content played on any number of jukebox systems in the network. Users can also view other jukebox system statistics from other venues and select content to be played from other venues at their current situated venue. Users can view other venues through a camera(s) located at the other venue, or send text messages to other venues. The multi-way jukebox system, therefore, can increase revenue by having more content selection, play, options, etc. That is, since more content is available for play at multiple venues, and since distribution of content, emergency information, etc. is more widespread, revenue is increased by more available purchasing options.

Since each jukebox can act as a content server (i.e., jukebox systems can hold all available selections due to the large disc drives, content can be transmitted to other jukebox systems in the network from another jukebox system or from a content server. One should appreciate that more uses and arrangements are capable with jukebox systems coupled in a network where the communication can flow in multiple directions, as opposed to standard jukebox systems that can only play content ordered from the specific jukebox at one specific venue that a user and the jukebox are both located at the same time.

With the features of the various embodiments, various uses can be employed by venue owners. For example, game shows can be made where hints are given and users try to search venues for objects or people through the camera system and display. Venues can be created (or franchises) that base the venue around a jukebox system (such as jukebox system 200/1450) and the multi-way communication. Television shows can be produced that use the statistical information for their charting purposes, whether at certain individual venues, venues in zones, or worldwide, etc. And, comedy type television shows can be produced that have content delivered to other venues where the content may not be expected. Therefore, different people's reactions can be shown when the unexpected content is delivered. These are just a few examples of other uses for the embodiments described. It should be noted that other uses can also benefit from the various described embodiments.

The above menus, programs, and processes can also be stored on a device or medium and read by a machine to perform instructions. The device or medium may include a solid state memory device and/or a rotating magnetic or optical disk. The device or medium may be distributed when partitions of instructions have been separated into different machines, such as across an interconnection of computers.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A jukebox system located at a first venue comprising:
a first display coupled to a controller,
a network interface coupled to said controller, said network interface to selectively transmit/receive data and content on a network,
a user interface coupled to said first display and said controller,
a first memory device and a second memory device both coupled to said controller,
an output router coupled to said controller,
an audio device coupled to said output router, and
a payment verification unit coupled to said controller,
wherein content can be selected on said jukebox system at said first venue and played on at least one other jukebox system located at a second venue and coupled to said network.

2. The jukebox system of claim 1, further comprising:
a second display coupled to said controller.

3. The jukebox system of claim 1, wherein a particular user can selectively view personal data displayed on said first display, said personal data is requested through said user interface by the particular user.

4. The jukebox system of claim 3, wherein personal data is stored on a user server coupled to said network.

5. The jukebox system of claim 4, wherein personal data includes user preferential selected content to display on a user menu on said first display, said user preferential selected content includes at least one list of content descriptions.

6. The jukebox system of claim 1, further including a plurality of menus generated by said controller to selectively display on said first display, wherein said menus are one of customizable lists of content descriptions, media disc graphics, and content descriptions and media disc graphics.

7. The jukebox system of claim 6, wherein said menus are dynamically updated based on content statistics from at least one jukebox system.

8. The jukebox system of claim 2, wherein content is emergency content, wherein said emergency content is played on one of said second display, said audio device, and said audio device and said second display.

9. The jukebox system of claim 8, wherein said emergency content is one of an amber alert, an Federal Bureau of Investigation alert, a local weather advisory alert, a local police alert, a presidential alert, an emergency broadcast system alert, and a local disaster alert.

10. The jukebox system of claim 1, wherein content is selectively chosen to play on any of said plurality of jukebox systems from a remote device, said remote device selectively coupled to said network.

11. The jukebox system of claim 10, wherein content can be selected to play at any number of selectively available jukebox systems coupled to said network.

12. The jukebox system of claim 11, wherein said selected content is selectively played simultaneously at said any number of selectively available jukebox systems coupled to said network.

13. The jukebox system of claim 2, further comprising:
at least one camera device coupled to said controller.

14. The jukebox system of claim 13, wherein said jukebox system selectively transmits images captured by said at least one camera to another jukebox system located at another venue.

15. The jukebox system of claim 1, wherein content statistics for any jukebox system located at any venue is selectively transmitted to any other jukebox system, and said content statistics are selectively used to generate display menus on said first display.

16. The jukebox system of claim 1, further comprising karaoke play option, wherein said karaoke play option one of filters vocals from selected content and plays content without a vocal track.

17. The jukebox system of claim 1, said content is originally located on a remote device, and said content is selectively distributed to said jukebox system from said remote device.

18. The jukebox system of claim 11, wherein selective availability is based on at least one of rating, connectivity, genre, timing, location, and cost.

19. The jukebox system of claim 1, wherein content play statistics are used to simultaneously play content at one of a predetermined statistical value and a random statistical value, and said content is played at one of a randomly determined time and a predetermined time simultaneously on each jukebox system coupled to said network.

20. The jukebox system of claim 1, wherein when no content is selected to play on a jukebox at a venue, content is selected to play by a management process running on a management server coupled to said network.

21. The jukebox system of claim 1, said content is originally located on said jukebox system, and said content is selectively distributed to at least another jukebox system from said jukebox system.

22. The jukebox system of claim 1, further comprising:
a content loading port, wherein content is loaded from one of said network and said jukebox system to a remote device.

23. The jukebox system of claim 22, further including one of a USB port, a USB retractable cable, and a wireless content delivery mechanism.

24. The jukebox system of claim 1, further comprising a compact disc writer, wherein content is selected by a user and copied onto a compact disc.

25. A jukebox network comprising:
a plurality of jukebox systems selectively coupled to a network, said plurality of jukebox systems having user interfaces for selection of content to be played;
at least one content storage device coupled to said network; and
at least one server coupled to said network, wherein content stored on one of said at least one content storage device and at least one jukebox system of said plurality of jukebox systems, is selectively transmitted to any of said plurality of jukebox systems, and a user at a venue where one of said plurality of jukebox systems is located can select any of said plurality of jukebox systems to play selected content where said plurality of jukebox systems are each located at different venues.

26. The jukebox network of claim 25, each of said plurality of jukebox systems comprising:
a first display coupled to a controller,
a network interface coupled to said controller, said network interface to selectively transmit/receive data and content on said network,
a user interface coupled to said first display and said controller,
a first memory device and a second memory device both coupled to said controller,
an output router coupled to said controller,
an audio device coupled to said output router, and
a payment verification unit coupled to said controller.

27. The jukebox network of claim 26, each of said plurality of jukebox systems further comprising:
a second display coupled to said controller.

28. The jukebox network of claim 26, wherein a particular user can selectively view personal data displayed on said first display, said personal data is requested through said user interface by the particular user.

29. The jukebox network of claim 28, wherein personal data is stored on a user server coupled to said network.

30. The jukebox network of claim 29, wherein personal data includes user preferential selected content to display on a user menu on said first display, said user preferential selected content includes at least one list of content descriptions.

31. The jukebox network of claim 26, further including a plurality of menus generated by said controller to selectively display on said first display, wherein said menus are one of customizable lists of content descriptions, media disc graphics, and content descriptions and media disc graphics.

32. The jukebox network of claim 31, wherein said menus are dynamically updated based on content statistics from at least one jukebox system.

33. The jukebox network of claim 26, wherein content is emergency content, wherein said emergency content is played on one of said second display, said audio device, and said audio device and said second display.

34. The jukebox network of claim 33, wherein said emergency content is one of an amber alert, an Federal Bureau of Investigation alert, a local weather advisory alert, a local police alert, a presidential alert, an emergency broadcast system alert, and a local disaster alert.

35. The jukebox network of claim 26, wherein content can be selected to be played on any of said plurality of jukebox systems from a remote device, said remote device selectively coupled to said network.

36. The jukebox network of claim 35, wherein content can be selected to play at any number of selectively available jukebox systems coupled to said network.

37. The jukebox network of claim 36, wherein said selected content is selectively played simultaneously at said any number of selectively available jukebox systems coupled to said network.

38. The jukebox network of claim 27, each of said plurality of jukebox systems further comprising:
at least one camera device coupled to said controller.

39. The jukebox network of claim 38, wherein any one of said plurality of jukebox systems selectively transmits images captured by said at least one camera to another jukebox system located at another venue.

40. The jukebox network of claim 26, wherein content statistics for any jukebox system of the plurality of jukebox systems located at any venue is selectively transmitted to any other jukebox system, and said content statistics are selectively used to generate display menus on said first display.

41. The jukebox network of claim 26, wherein said network is the Internet, and said network interface is coupled to the Internet by one of a wireless connection and a wire connection.

42. The jukebox network of claim 26, said content is originally located on a content server coupled to said network, and content is selectively distributed to said jukebox system from said content server.

43. The jukebox network of claim 26, said content is originally located on a remote device, and said content is selectively distributed to said jukebox system from said remote device.

44. The jukebox network of claim 36, wherein selective availability is based on at least one of rating, connectivity, genre, timing, location, and cost.

45. The jukebox network of claim 37, wherein selective availability is based on at least one of rating, connectivity, genre, timing, location, and cost.

46. The jukebox network of claim 26, wherein content play statistics are used to simultaneously play content at one of a predetermined statistical value and a random statistical value, and said content is played at one of a randomly determined time and a predetermined time simultaneously on each jukebox system coupled to said network.

47. The jukebox network of claim 26, when no content is selected to play on a jukebox at a venue, content is selected to play by a management process running on a management server coupled to said network.

48. The jukebox network of claim 26, wherein said content is originally located on a first jukebox system of said plurality of jukebox systems, and said content is selectively distributed to at least another jukebox system of the plurality of jukebox systems from said first jukebox system.

49. The jukebox network of claim 26, wherein at least one jukebox system of said plurality of jukebox systems includes a content loading port, wherein content is loaded from one of said network and said at least one jukebox system to a remote device.

50. The jukebox network of claim 49, wherein said at least one jukebox system further includes one of a USB port, a USB retractable cable, and a wireless content delivery mechanism.

51. The jukebox network of claim 26, wherein at least one jukebox system of said plurality of jukebox systems includes a compact disc writer, wherein content is selected by a user and copied onto a compact disc.

52. A method comprising:
selecting content to play at least one available venue on a jukebox system,
determining venue availability in a jukebox network,
selecting at least one available venue in said jukebox network,
determining amount of credit necessary to play said content at said available venue,
verifying credit is received,
determining if said content is one of locally stored and remotely stored,
requesting transmission of said content if said content is determined to be remotely stored,
playing said content on said jukebox system at said selected at least one venue,
wherein said jukebox system is any selectively available jukebox system in said jukebox network.

53. The method of claim 52, wherein playing comprises:
one of converting said content to video signals and displaying said video signals on a display, converting said content to audio signals and transmitting said audio signals through an output device, and converting said content to video signals and displaying said video signals on a display and converting said content to audio signals and transmitting said audio signals through an output device.

54. The method of claim 52, wherein further including:
requesting transmission of personal data to a jukebox system in said jukebox network,
transmitting said personal data to said jukebox system in said jukebox network,
displaying said personal data in a user menu on a display of said jukebox system.

55. The method of claim 52, further including:
generating a plurality of menus to selectively display on a first display, wherein said menus are customizable lists of content descriptions, media disc graphics, and content descriptions and media disc graphics.

56. The method of claim 55, wherein said menus are dynamically updated based on content statistics from at least one jukebox system.

57. The method of claim 53, wherein content is emergency content, wherein said emergency content is played on one of said second display, said audio device, and said audio device and said second display.

58. The method of claim 57, wherein said emergency content is one of an amber alert, an Federal Bureau of Investigation alert, a local weather advisory alert, a local police alert, a presidential alert, an emergency broadcast system alert, and a local disaster alert.

59. The method of claim 52, wherein content can be selected to be played on any jukebox system in said jukebox network from a remote device, said remote device selectively coupled to said network.

60. The method of claim 52, wherein said selected content is selectively played simultaneously at said any number of selectively available jukebox systems in said jukebox network.

61. The method of claim 52, further including:
selectively transmitting images captured by at least one camera coupled to a jukebox system to another jukebox system in said jukebox network located at another venue.

62. The method of claim 55, further including:
selectively transmitting content statistics for any jukebox system in said jukebox network located at any venue to any other jukebox system in said jukebox network, and said content statistics are selectively used to generate display menus on said first display.

63. The method of claim 52, said content is originally located on a remote device, and said content is selectively distributed to said jukebox system from said remote device.

64. The method of claim 63, wherein venue availability is based on at least one of rating, connectivity, genre, timing, location, and cost.
